(19) United States
(12) Patent Application Publication
(10) Pub. No.: US 2008/0298865 A1
(43) Pub. Date: Dec. 4, 2008

(54) Ablation collection system for an image recorder

(76) Inventors: Stephen R. Manning, North Andover, MA (US); Torsten Platz, Cambridge, MA (US)

Correspondence Address: AGFA;c/o KEATING & BENNETT, LLP, 1800 Alexander Bell Drive, SUITE 200, Reston, VA, 20191, US

(21) Appl. No.: 11/807,859

(22) Filed: May 30, 2007

(51) Int. Cl. G03G 21/00

(52) U.S. Cl. 399/347

(57) ABSTRACT

An apparatus is mounted on a moveable carriage of an external drum platesetter for removing air-borne ablative particles caused when a printing plate mounted on an outside surface of a rotating drum of the platesetter is imaged via a laser source having a window for transmitting a laser beam. The apparatus includes a nozzle, a redirecting surface and a vacuum chamber. The nozzle transmits a line of compressed air towards the redirecting surface which in turn redirects and splits the line of compressed air into two parts. A first part is directed towards the drum and a second part is diverted towards the laser window. The vacuum chamber is connected to a vacuum channel for removing air including the ablative particles.

### BACKGROUND OF THE INVENTION

The invention is in the field of image recording by ablation of a printing substrate. More particularly, the invention relates to the collection of ablative particles after thermal imaging of a printing plate mounted on an external drum platesetter.

In the pre-press printing industry, a printing plate is manufactured on a platesetter also known as a platemaker. The printing plate is later mounted onto a printing press for commercial industrial printing applications such as printing magazines, newspapers, books, posters, etc.

Platesetters can be flat-bed, external drum or internal drum machines. A flat-bed machine provides a planar surface for mounting the printing plate for imaging. In an internal drum platesetter such as the Agfa Galileo™, the printing plate is mounted onto an inside surface of a drum. In an external drum platesetter such as the Agfa Avalon™, the printing plate is mounted onto an outside surface of a drum. In all of these machines, it is necessary to scan a laser beam or beams across the printing plate when mounted on the support substrate in order to transfer an image thereto.

U.S. Pat. No. 5,574,493 issued on Nov. 12, 1996 to Sanger et al. discloses a vacuum collection system for a dye-ablation printing process. As viewed in Sanger FIG. 1, an external drum platesetter has a printing plate 10 mounted on an outer surface of the drum 12. An image is formed on the printing plate using an ablative mode of laser imaging. The ablation process causes dust, particles and contaminants to become airborne. Sanger discloses an ablative materials collection apparatus which includes: a vacuum chamber 18 that opens towards the drum 12; a vacuum source that provides a vacuum to the chamber 18 through a tube 30; and an electrostatic air cleaner 32 which in turn is connected to a carbon filter 34. While the image is being transferred to the printing plate 10 via ablative laser imaging, the resultant air-borne contaminants are removed by the pressure differentiation of the vacuum through the tube 30 and into the air cleaner which charges the particles, which are then deposited onto oppositely charged plates. Carbon particles in the carbon filter 34 eliminate any possible odors and/or gases discharged into the air.

Sanger further provides a heat source adapted to apply heat to the vacuum chamber to inhibit adherence of ablated particles to surfaces of the vacuum chamber. Adherence of ablated particles to surfaces of the vacuum chamber is further inhibited by the application of solvents into the vacuum chamber.

U.S. Pat. No. 7,209,157 issued on Apr. 24, 2007 to Isono et al. discloses a system for removing gases and air impurities such as dust and ash after thermal laser imaging on an external drum platesetter. Isono discloses the use of two suction units so that if the imaged plate generates a large quantity of gas that cannot be totally removed by a single suction unit, then the second suction unit will be able to remove the remainder of the gases and dust particles. Furthermore, the length of the second suction unit is (i) larger than the length of the recording drum along the direction of the rotational axis, and (ii) is also larger than the width of the printing plate mounted on the drum. Isono discloses the use of a plurality of air injection ports for spraying the imaged plate with air at an acute angle to the tangent of the external surface of the drum. The quantity of air supplied to the gas diffusion/suction unit is regulated via a regulating valve.

### SUMMARY OF THE INVENTION

It is an object of the present invention to provide an improved method and system for use in an external drum platesetter to remove air-borne particles that are ablated from a printing plate by laser imaging.

An apparatus is mounted on a moveable carriage of an external drum platesetter for removing air-borne ablative particles caused by imaging a printing plate mounted on an outside surface of a rotating drum of the platesetter via a laser source having a window for transmitting a laser beam therethrough. The apparatus includes: a nozzle with a slit opening for transmitting a line of compressed air towards a redirecting surface that is angled to redirect and split the line of compressed air into two parts, a first part being substantially coplanar with a rotational axis of the drum and forming an angle substantially perpendicular to a tangent of the drum, and a second part diverted towards the laser window; and a vacuum chamber connected to a vacuum channel for removing a combination of the compressed air and an air flow about the drum.

A velocity of the first part of the line of compressed air is set to be substantially equal to a velocity of the air flow about the drum due to the drum rotation, where the air flow about the drum contains air-borne ablative particles from the printing plate due to the ablative laser imaging.

### BRIEF DESCRIPTION OF THE DRAWINGS

The aforementioned aspects and other features of the invention are described in detail in conjunction with the accompanying drawings, not drawn to scale, in which the same reference numerals are used throughout for denoting corresponding elements.

FIG. 1 is a perspective view of selected components of an external drum platesetting system as known in the prior art;

FIG. 2 is a front to side perspective view of an apparatus for removing air-borne ablative particles in accordance with the principles of the invention; and

FIG. 3 is a diagrammatic cutout side view of the apparatus of FIG. 2 for removing air-borne ablative particles when mounted on a carriage of an external drum platesetter in accordance with the principles of the invention.

### DETAILED DESCRIPTION OF THE PREFERRED EMBODIMENTS

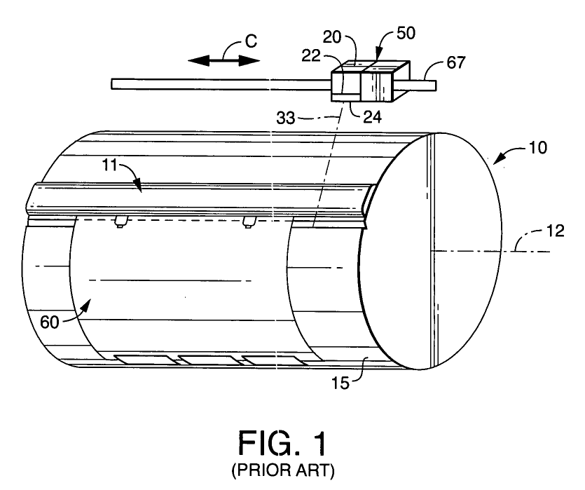

Selected components of a prior art external drum platesetter are illustrated in FIG. 1. In the external drum platesetter, a printing plate 60 is mounted onto an external surface 15 of a drum 10. The imaging head 20 is mounted on a moveable carriage 50 in the vicinity of the drum. A laser beam 33 is emitted from the laser source 22 through the laser window 24. The laser beam 33 could be a single laser beam or more typically a laser line for transferring an image to the printing plate 60. As the drum rotates, the carriage 50 moves in a linear direction C along the length of the drum on a rail 67 and an image is emitted from the laser beam 33 onto the printing plate 60.

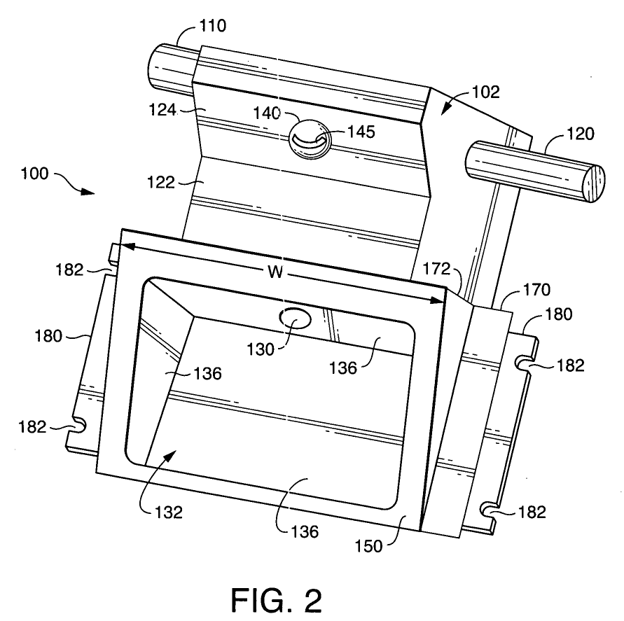

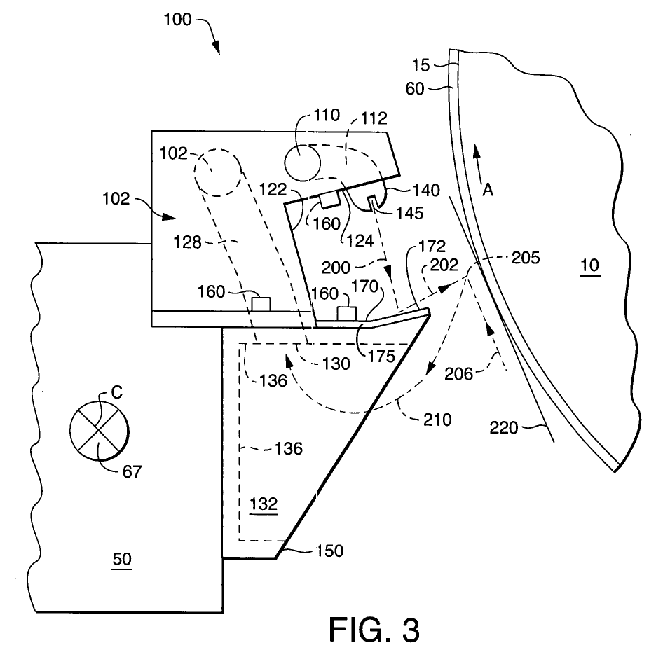

The inventive apparatus is presented in FIG. 2 in a front to side perspective view, and in FIG. 3 from a diagrammatic cutout side view. The following preferred embodiments are described with reference to both figures.

An external drum platesetter transfers an image from the laser imaging head 20 mounted on the carriage 50 to the printing plate 60 mounted on the external surface 15 of the drum 10 while the drum and plate 60 are rotated in a direction A as shown in FIG. 3. The rotation of the drum 10 creates an air flow or current adjacent to the drum which follows the direction of the drum rotation.

The imaging head 20 houses the imaging optics which includes a laser source 22 with a window 24 for transmitting the laser beam 33 therethrough to the printing plate 60 mounted on the platesetter. The imaging head 20 together with the ablation particle removal apparatus 100 are mounted on the carriage 50 which in turn travels the length of the drum 10 along the beam 67 (see FIGS. 1 and 3). When the laser beam 33 heats the printing plate 60, it causes gases, dust and other ablated particles to break away from the plate 60 and to become vaporized to form a cloud 206 that follows the air flow circling the drum 10 moving in the direction A. Without any preventative action, as time passes the cloud 206 will break away from the orbit of the drum rotation and undesirably dissipate into the surrounding air. Some of the particles of the cloud 206 would eventually settle onto the window 24 of the laser source 22 and onto other optical components which pass or reflect the laser beam 33. This tarnishment of optical components will eventually cause fluctuations in the intensity and accuracy of imaging in the system.

In order to minimize the dissipation of ablated particles into the surrounding air, the ablation removal apparatus 100 is positioned to follow slightly behind the laser imaging beam so as to remove the ablated particles from the air as soon as possible after ablation. Thus as the carriage 50 moves linearly along the beam 67, it is desired to remove the resultant cloud 206 of ablated particles as soon as possible and preferably within one of two rotations about the drum.

It is noteworthy that the ablation removal apparatus 100 as shown in FIGS. 2 and 3 is a relatively small device measuring only a few inches in each dimension of length, width and height. The apparatus 100 is mounted on the carriage 50 and moved along the rail or beam 67 along with the imaging head 20. The apparatus 100 does not expand the width of the drum 10.

The ablation particle removal apparatus 100 includes a body 102 which could be machined, assembled or built from any suitable material such as, but not limited to, metals, plastics or composites. The apparatus 100 includes any known means for mounting the apparatus to the carriage 50. For instance, the embodiment of FIG. 2 shows mounting brackets 180 having slots or holes 182 whereby the apparatus 100 could be mounted by screws onto the carriage 50. Also shown are screws, nuts, bolts or rivets 160 that could be used to assemble and hold together various sections of the apparatus 100.

The ablation particle removal apparatus 100 includes a vacuum chamber 132 having walls 136. A vacuum source (not shown) is connected to the vacuum chamber 132 via a tube 120 and a channel 128 which pulls air from the chamber 132 through the orifice 130.

A compressed air source (not shown) provides compressed air to the apparatus 100 through an intake hose 110 and a channel 112 to an outlet 145 of the nozzle 140. The outlet 145 is preferably structured as a slit so as to provide a line 200 of compressed air flow.

In the preferred embodiment, the apparatus 100 includes a cavity for air flow redirection. This is clearly shown in the figures where the nozzle 140 and the redirection surface 172 are indented into a cavity so that the air flow 200 is reflected or redirected from the redirection surface 172 towards the plate 60. The cavity in this example is bordered by an upper surface 124, a rear surface 122 and the redirection surface 172. The redirection surface or redirecting plate 172 is angled as shown in the drawings so as to redirect and split the line of compressed air flow 200 into two parts. The first part of the redirected air flow is substantially coplanar with a rotational axis 12 of the drum 10. This means that the line of redirected air flow of the first part falls in a plane formed with the intersection of the rotational axis 12 of the drum 10, given some approximate margin of error of, for example, up to 3 degrees.

The first part 202 of the redirected line of air flow also forms an angle that is substantially perpendicular to a tangent 220 of the drum 10. This is the angle formed by the intersection of the first part 202 of the redirected air and the tangent 220. This angle is approximately 90 degrees with a possible margin of error up to 3 degrees. A second part (not shown) of the redirected line of air flow 202 from the redirection surface 172 splits off and eventually encounters the window of the laser source. In this way, the second part of the redirected air flow will help to keep the window of the laser source free from ablative contaminants, dust, etc.

The operation of the invention is as follows. As the carriage 50 moves linearly along the support beam 67 from right to left as viewed in FIG. 1, an image is transferred to the printing plate 60 via the laser beam 33 which originates from the laser source 22 mounted on the carriage 50. The ablation particle removal apparatus 100 shown in FIGS. 2 and 3 is also mounted on the carriage 50, so that the apparatus 100 follows behind the laser beam 33. As the beam 33 images the plate 60, it causes a cloud of ablated particles 206 to begin orbiting around the drum 10 in the direction A. The line of compressed air 200 is emitted from the nozzle slit 145, then reflected and split from the redirection surface 172 and split into two parts. The first part of the line of air flow is redirected towards the plate 60 at an angle approximately perpendicular to a tangent 220 of the external surface 15 of the drum 10. The first redirected line of air 202 collides with the ablation cloud 206 along a knit line 205 having the same width W as the line of air 202.

The primary purpose of the redirection surface 172 is to reflect and redirect the first part of the line of air 202 so that when it intersects with the ablation particle cloud 206 along the knit line 205, the resultant combination 210 of the compressed air line 202 and the ablated particle cloud 206 will peel away from the knit line 205 in a direction towards the vacuum chamber 132.

A secondary purpose of the redirection plate or surface 172 is to reflect and redirect the second part of the line of air 202 so that it will eventually encounter the window 24 of the laser source 22, thus helping to keep the laser window 24 free from ablative particles, dust and other contaminants.

The vacuum from the orifice 30 will suction and remove air from the vicinity of the vacuum chamber 132, including the combined air 210 from the knit line 205, through the orifice 130, then through the vacuum channels 128 and 120 to a filter (not shown) or to an outside atmosphere away from the internal components of the platesetter, thus purifying the air within the platesetter and removing contaminants therefrom. In this way, the deposition of the particles, gases, dust and contaminants from the ablated printing plate will not settle onto the laser window 24, other optical components of the imaging head, the final imaged printing plate, or any other components of the platesetting system.

While this invention has been particularly shown and described with reference to selected examples or embodiments, the principles of the inventive system and the method thereto are applicable for any application of removing a cloud of ablated particles that are orbiting about a rotating drum.

1. An apparatus mounted on a moveable carriage of an external drum platesetter for removing air-borne ablative particles and gases caused by imaging a printing plate mounted on an outside surface of a rotating drum of the platesetter via a laser source having a window for transmitting a laser beam, the apparatus comprising:
a nozzle with a slit for transmitting a line of compressed air towards a redirecting surface;
said redirecting surface angled to redirect and split the line of compressed air into two parts, a first part being substantially coplanar with a rotational axis of the drum and forming an angle substantially perpendicular to a tangent of the drum, and a second part diverted towards said laser window; and
a vacuum chamber connected to a vacuum channel for removing a combination of the compressed air and an air flow about the drum,
wherein a velocity of the first part of the line of compressed air is set to be substantially equal to a velocity of the air flow about the drum due to the drum rotation, and wherein the air flow about the drum contains the air-borne ablative particles from the printing plate due to the ablative laser imaging.
